(19) United States
(12) Patent Application Publication
(10) Pub. No.: US 2018/0033329 A1
(43) Pub. Date: Feb. 1, 2018

(54) MODIFYING TEXT APPEARANCE AND DISPLAY PROPERTIES TO IMPROVE READING EFFICIENCY

(71) Applicant: Anver S. SULEIMAN, St. Pete Beach, FL (US)

(72) Inventor: Anver S. SULEIMAN, St. Pete Beach, FL (US)

(21) Appl. No.: 15/650,564

(22) Filed: Jul. 14, 2017

Related U.S. Application Data
(60) Provisional application No. 62/366,676, filed on Jul. 26, 2016.

(51) Int. Cl. G09B 17/04; G09B 17/02; G09B 21/00; G09B 17/00

(52) U.S. Cl. CPC G09B 17/04; G09B 17/003; G09B 17/02; G09B 21/008

(57) ABSTRACT

A method is disclosed where modified text, text display, and rate are performed to make reading more efficient including speed, comprehension, and retention. The text is displayed at a reader-controlled variable rate, in logical lines, emphasizing nouns and verbs vs. their modifiers, i.e., adjectives and adverbs in a manner that makes it easier for the reader to move through the text efficiently. These modifications, and others, are built into the reading software/application/system context, i.e., virtual or augmented reality or flat display, and can be tailored by reading material type, reader purpose, and reader personal preferences vs. the default positions for type and purpose. This method can be applied to any form of electronic display or interface and also may be specifically applied to printed material by performing some of these functions while preparing the product for printing. The text may be further annotated/modified while reading in accord with user goals.

### FIELD OF THE INVENTION

The invention is directed to the field of using various methods and techniques, especially including those that are software-enabled and controlled, to allow the reader, teacher or information provider to modify the appearance/characteristics, display and rate of display of text by material category, reader purpose and preferences to enable more time efficient comprehension and retention of the text so modified.

### BACKGROUND OF THE INVENTION

Techniques to increase reading efficiency have been around since the advent of the industrial age. In its original form, the primary object of these techniques was to enhance reader focus, reduce distraction, and increase rate of exposure to text through learned eye movement, scanning, etc. and by reducing the common practice of subvocalizing words and/or “going back over material” thereby slowing up the rate at which one could read and absorb information. This was effective for some people, both as an aid and as a training methodology, and certainly as more and more people headed for post-secondary and post-graduate education and training, the ability to cover the assigned materials more quickly gave an advantage to the users of such systems. With the advent of the web enabled media age the geometric expansion of text to be consumed has overwhelmed convention.

Current state-of-the-art technology does not modify text as read/processed in order to make it more time-effective, understandable and memorable either for material category or reader purpose and preference. And, other than minor selection criteria, even print text is only rudimentarily modified in advance of printing or viewing for readability e.g., serif vs non-serif, italics, bold, underline, etc. on a fairly fundamental, and largely aesthetic basis vs. for actually increasing reading efficiency, i.e., speed, comprehension and retention of reading materials. Even teaching reading and language teaching modifications are used primarily on these very fundamental levels.

Given the sheer volume of consumable media in text form, there is a need to use the basic nature of how the brain works to gather information from text, whether through shape, dimension, emphasis, and/or position, and to supply a consumer of such media with customizable tools, using all appearance and contextual variables, to assist them in their particular goal/purpose and tailored for the category of material being read/viewed.

### SUMMARY OF THE INVENTION

The invention relates to various features including: 1) Identifying and differentiating specified parts of speech (POS) and/or subject, verb, object (SVO) and altering the appearance and/or position of those identified parts to a user's set, or controlled in real time so as to alert the reader to context by aiding neural processing by using text differentiation to show the relationships between parts of speech, e.g. verbs and their adverbs, nouns and their adjectives, as well as subjects, verbs and objects, and other identifiable language components, to provide relevant context as an additional aid to neural processing. This can be accomplished in a variety of ways by size, shade, typeface, location/proximity, etc. All of which will immediately and intuitively assist in absorption of the material and additionally will increase effectiveness with repeated experience. 2) Default and modifiable settings for category of material, purpose for reading, and/or personal preferences for that text. 3) Controlling the amount of material (line length and number of lines) at which the text is displayed/read at set or variable speeds and controlled by retina tracking, facial motion tracking, or external device tracking, voice command, touch or pressure sensing, or by any of various extant techniques. 4) Limiting line length/break points in a manner determined by a logic priority order and specified point range e.g., by location of period, colon, semicolon, comma, preposition, or other logical sequence (logichunk) so that lines include relatively logical complete or partially complete phrases and/or thoughts without illogical breaks that interfere with logical thought processing. 5) Providing an oscilloscope-derived wave-form background pattern or wave-form modified text thereby providing a guide to pronunciation, or for teaching languages or ESL, or for teaching the deaf. 6) Using speed-selected music or other auditory input as an optional adjunct to coincide with the speed selected to minimize sub-vocalization and “going back” needlessly. 7) The ability for the reader to select both material category and reader purpose for reading specific material and the option of further modifying default settings for personal preference including, but not limited to: identifying key words or phrases for specific treatments for highlighting, underlines, or other identifying treatment; review readings; study, etc. 8) Adding already developed open source or licensed software modifications for pronunciation, meaning, annotating, etc. 9) Using virtual reality (VR) and/or augmented reality techniques (AR) to allow the reader to select options that increase effectiveness of reading.

Commercial embodiments of the system may include: 1) A Kindle-type or other reader types. This would enable the material read to be modified and displayed as above thereby increasing and continuously improving reading efficiency (speed, comprehension, retention). 2) Installed or purchased software on any laptop, desktop, mobile device, with or without a virtual reality capability, etc. thereby accomplishing the same goal of improving reading efficiency. 3) As an integral part of any software used to teach children or adults thereby increasing the student's ability to understand and retain the principles being taught. 4) As an integral part of any software used to teach a language thereby increasing the student's ability to learn the language more efficiently. 5) As an integral part of any software used to correct a reading disorder e.g., dyslexia by increasing the reader's ability to process reading material more effectively. 6) As an integral part of any software used to teach physically disabled, e.g. deafness, mental handicapped. 7) As an integral part of new or extant virtual reality (VR) or augmented reality (AR) software.

### BRIEF DESCRIPTION OF THE DRAWINGS

FIG. 1 is a welcome screen text to orient a user to the capabilities of the invention.

FIG. 2 is another initial screen text where a user initializes system use by selecting a text category.

FIG. 3 is another initial screen text to obtain user purpose or intent in relation to the treated text.

FIG. 4 is a Settings Screen where a user can accept “default” or select “custom” test treatments.

FIG. 5 is another settings screen for user interface control, in this instance for Pace control during use.

FIG. 6 is another settings screen where, when a logical text grouping feature is used, the user can set parameters for line length and number.

FIG. 7 is another settings screen for user modification of parts of speech, again default settings are useable until such time as user can appreciate what factors provide the most assistance for their goal.

FIG. 8 is another settings screen to adjust color and shading for parts of speech.

FIG. 9 is another settings screen for adjusting font size of parts of speech.

FIG. 10 is another settings screen for changing and adjusting type face of parts of speech.

FIG. 11 is another settings screen for adjusting parts of speech in grouped treatments.

FIG. 12 is another settings screen for separately adjusting parts of speech in an individual fashion.

FIG. 13 is a settings query page for specified words and phrases.

FIG. 14 is an annotation settings page.

FIG. 15 is a text effect modulator corresponding to a spoken version of the text.

FIG. 16 is a swipe functions page for user interface, where lateral and vertical swipe actions for touch screens can be enabled.

FIG. 17 is a text sample prior to treatment using the system.

FIG. 18 is the text from FIG. 17 being modified using logical grouping.

FIG. 19 is a treated text having both logical grouping and parts of speech modification.

FIG. 20 is a treated text having logical grouping, parts of speech modification and line emphasis.

FIG. 21 is a settings screen for line count emphasis.

FIG. 22 is a conceptual diagram showing the systems capabilities in a virtual reality setting.

FIG. 23 is a “mind-map” of features and capabilities for the proposed system

### DETAILED DESCRIPTION OF THE INVENTION

The invention will now be described with respect to certain referred versions thereof. The scope of this invention is not intended to be limited by this disclosure, but rather only by the appended claims. To provide technical enablement of the method herein, the following documents are herein incorporated in their entirety by reference thereto: US20020091713A1; US2006012922A1; US20150286618A1; U.S. Pat. No. 5,802,533A; U.S. Pat. No. 6,279,017B1; U.S. Pat. No. 7,036,075B2; U.S. Pat. No. 7,765,471B2; U.S. Pat. No. 7,861,163B2.

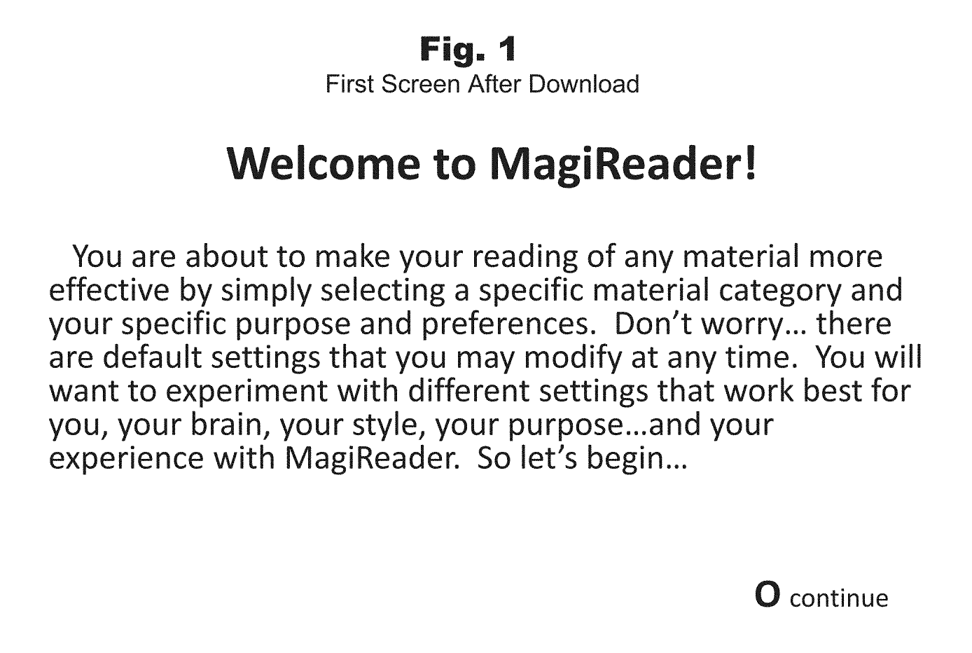

FIG. 1 is a welcome screen text to orient a user to the capabilities of the invention. When a user encounters the invented system for the first time, either in an app provided by the text source, or from the user's own download, a certain familiarity will be necessary for the best use of the system to result. Hence, the text provides reassurance that a pass through the various settings screens is a “can't miss” proposition wherein default settings based on reader research and outcomes will fill-in where the user cannot decide a setting or skips the question(s) entirely.

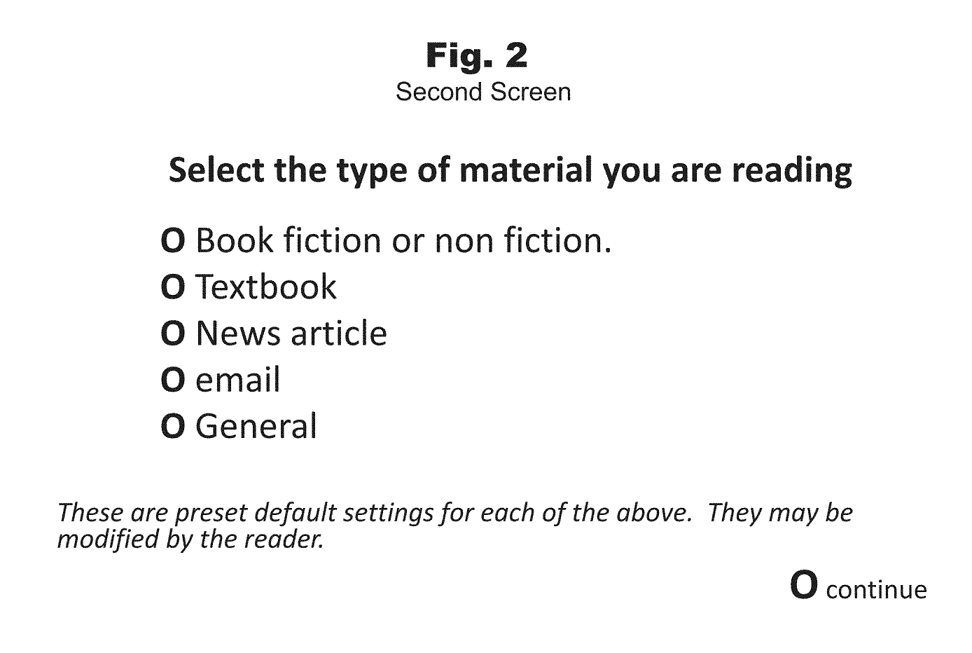

FIG. 2 is another initial screen text where a user initializes system use by selecting a text type. A text type selection implies an intent or desire on the part of the user. It may be compatible with the user intent or perhaps not. A casual user would choose fiction in a different context that a student reading a text for grading, etc. Likewise, a new article in one person's field of expertise might be treated differently than a treatment for a lay person in that same field. However, any defaults can be adjusted in accord with user goals.

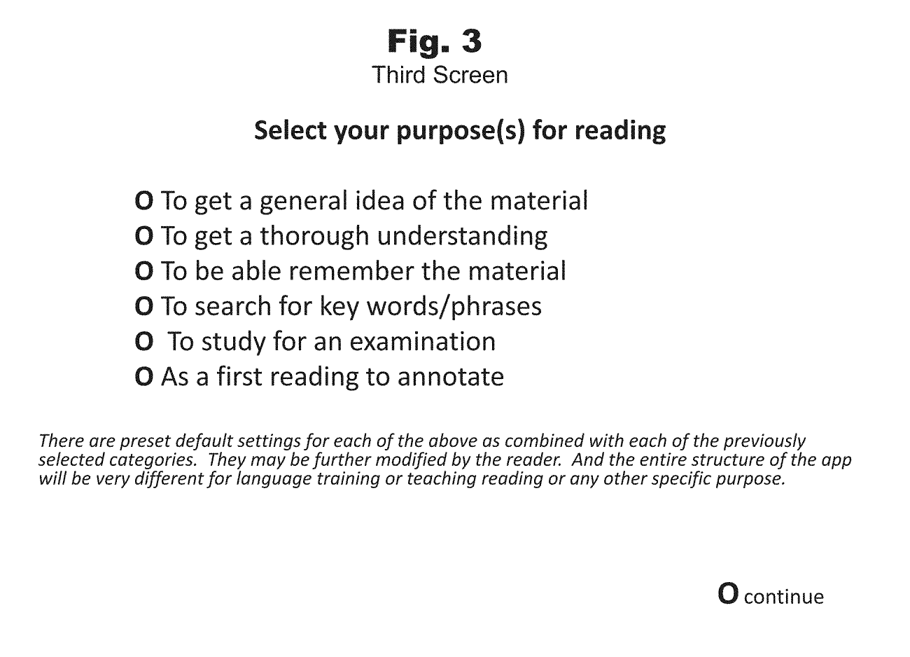

FIG. 3 is another initial screen text to obtain user purpose or intent in relation to the treated text. After choosing text type, with the qualified assumptions from FIG. 2, a specific intent or goal of the system user may be reflected using the purpose screen. Again, specific subject matter expertise will likely play a role. A thorough understanding for a first time reading without particular expertise would be quite distinct from a first time reading where the background of the reader is quite deep as regards the topic(s) of the text. Again, however, default assumptions can be overridden with familiarity with the system and goals of the user.

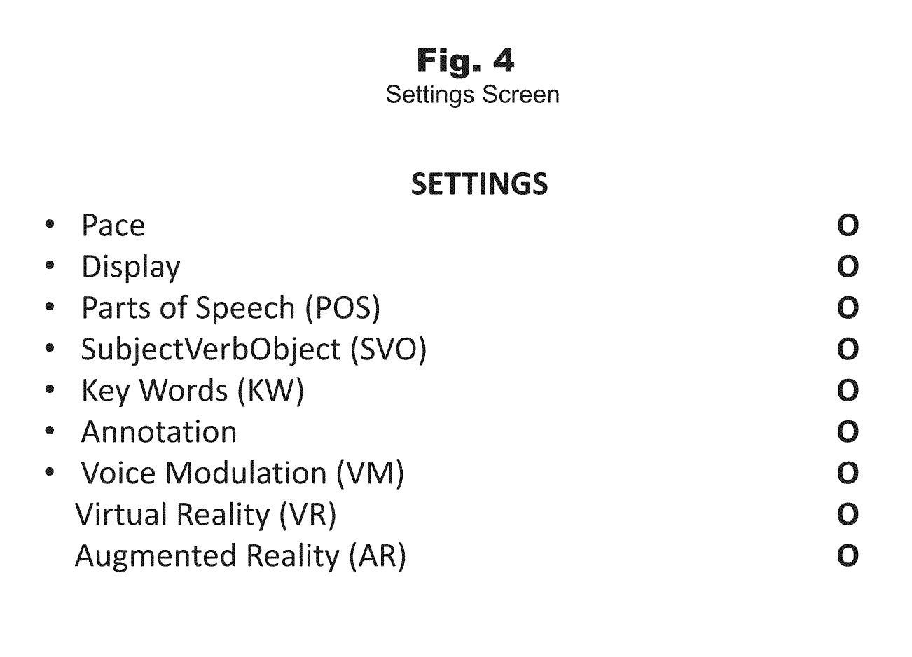

FIG. 4 is a Settings Screen where a user can accept “default” or select “custom” text treatments in a generalized sense. These settings can default to past use settings of that user, or to default(s) based on researched results for this type of use by others. It may be user education reliant, user expertise reliant, physical limitation reliant, or other relevant factor that speeds or slows or otherwise changes the settings. In addition, once set, any of the settings can be adjusted during use where the user finds a different pace, emphasis, display, etc. are warranted.

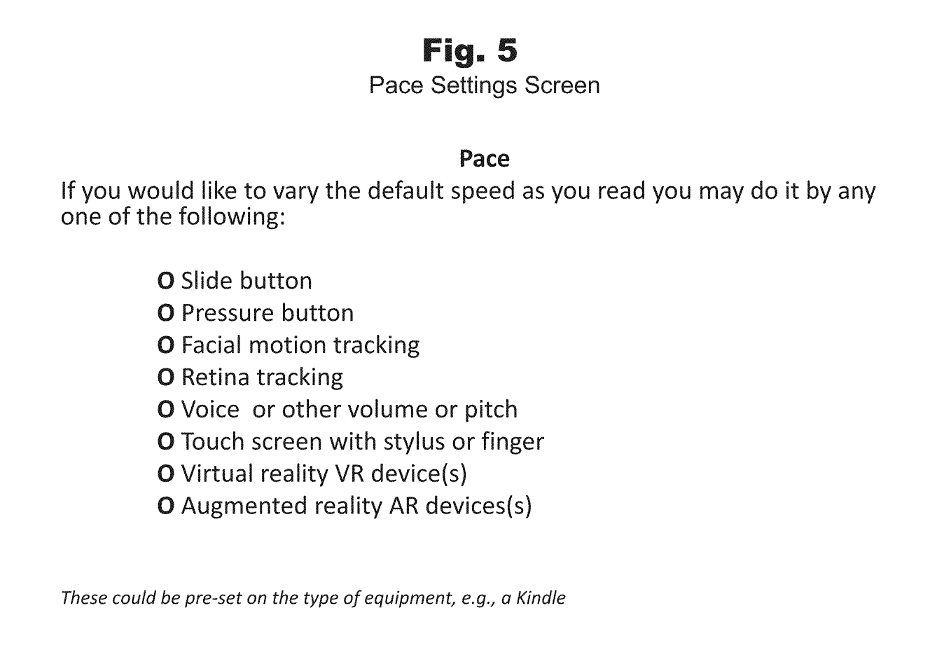

FIG. 5 is another settings screen for user interface control, in this instance for example, for Pace control during use. A user selects the nature of the interface for that particular setting. Touch screen, mouse, roller ball, retinal tracking, etc., can be relied on to regulate pace on a “sensed” basis or on a controlled basis, i.e., as set by the user. It may be that the pace is also used as a training function to speed or slow a person, who is habitually on one side or the other of ideal for the purpose they seek.

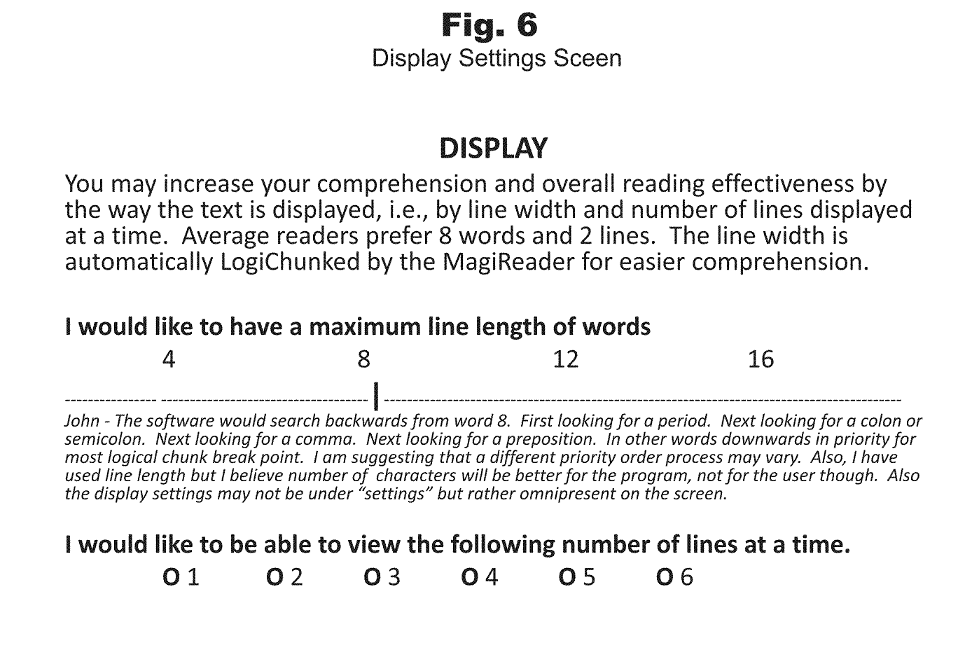

FIG. 6 is another settings screen where, when a logical text grouping feature is used, the user can set parameters for line length and number. This feature relies on the notion that a person can grasp multiple words, phrases, and text groupings where they are more logically presented. The collation of text into related word groupings may hasten both speed and comprehension. It is easier, for example, to read a numeric list in single column descending format. This format, however, makes sentence reading near impossible. Hence, the line length and collection of words into logical groupings, herein called “LogiChunked”, may be set by the reader in accord with goals and the nature of the text being modified. Simply changing the paragraphs stacked columns into uniform lengths may without any words broken line to line may alter a user experience in a profound way.

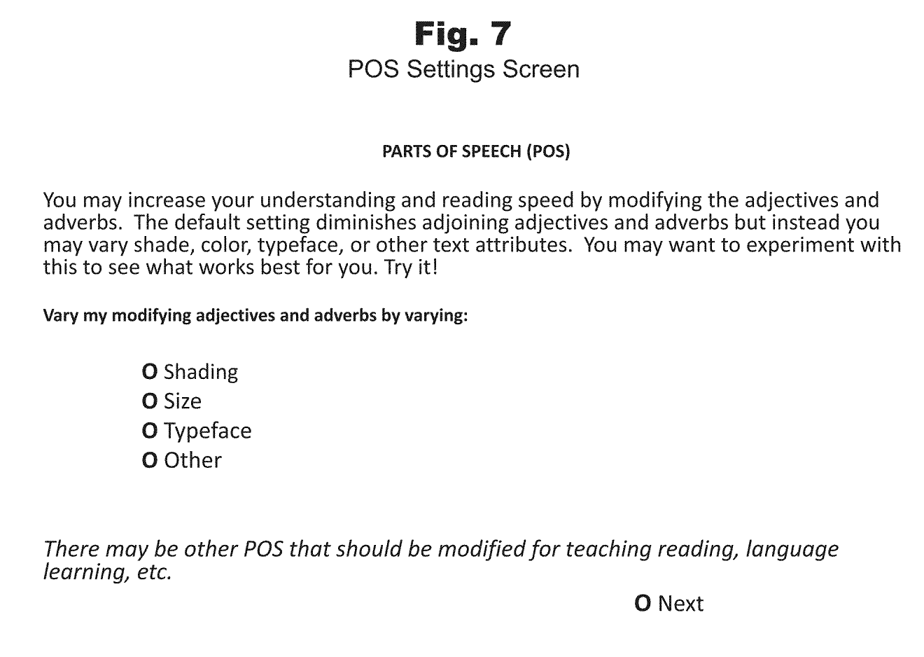

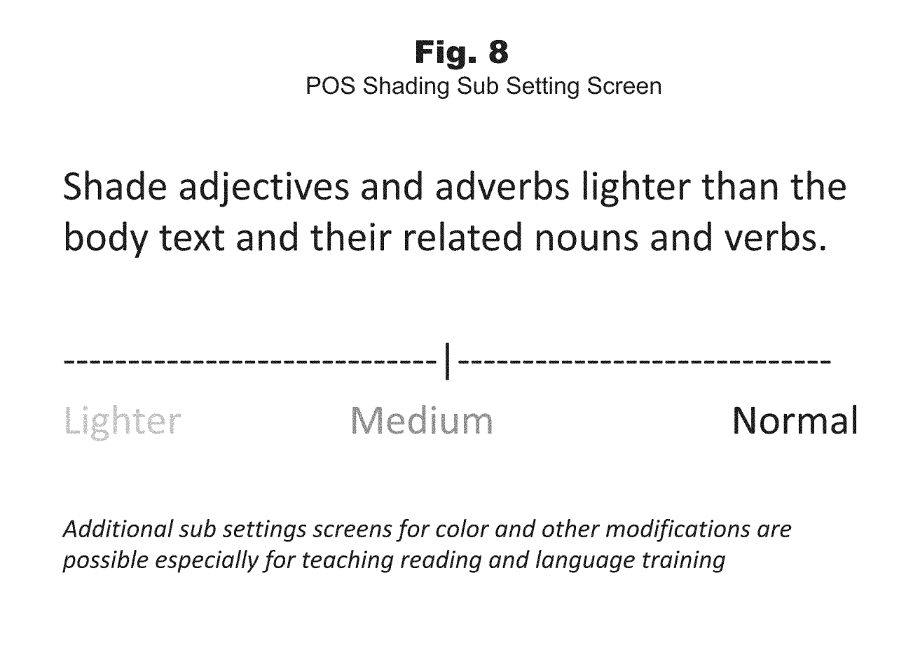

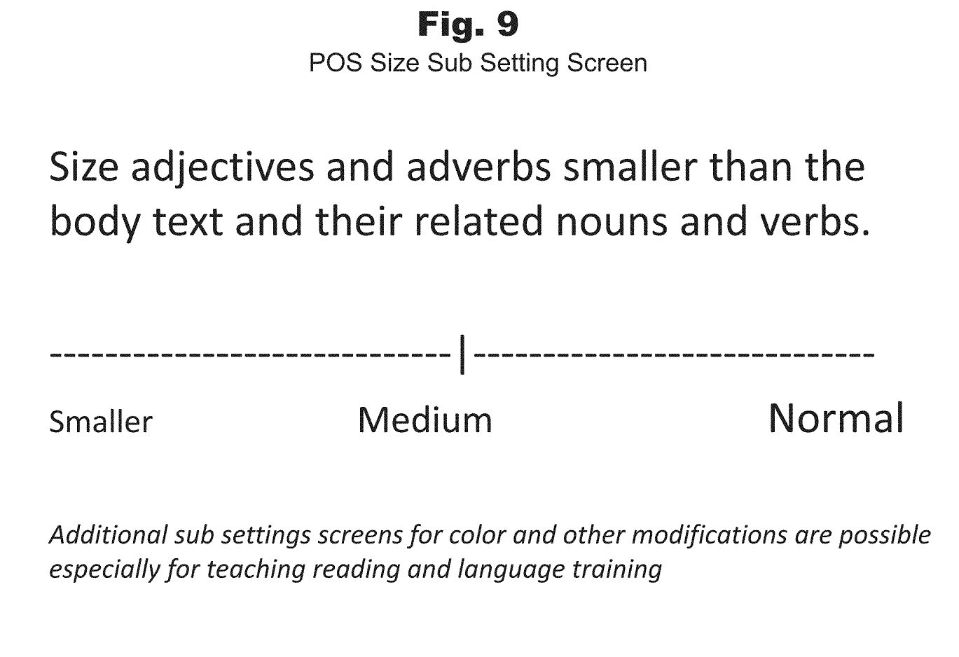

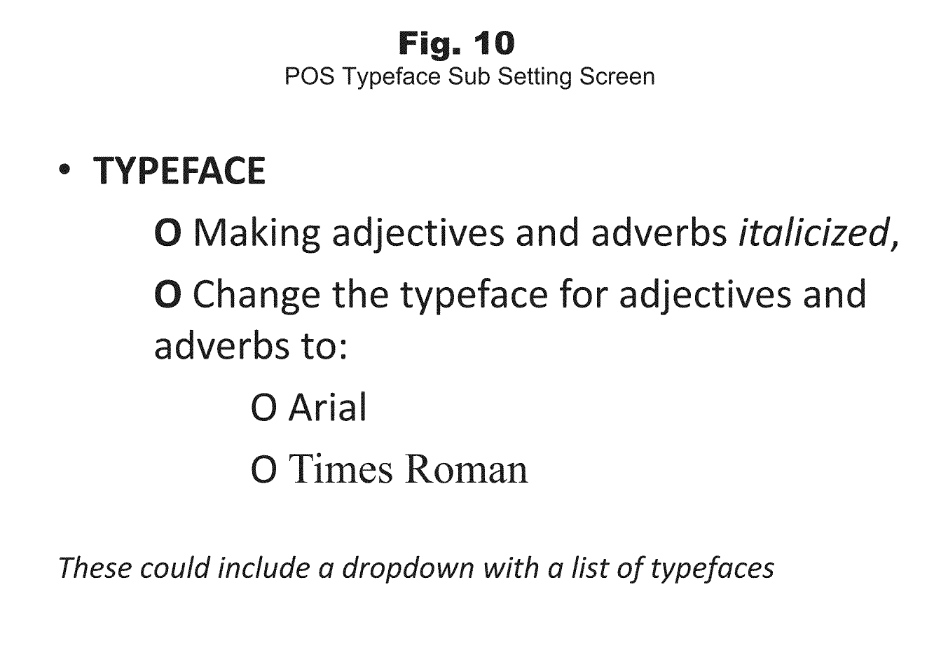

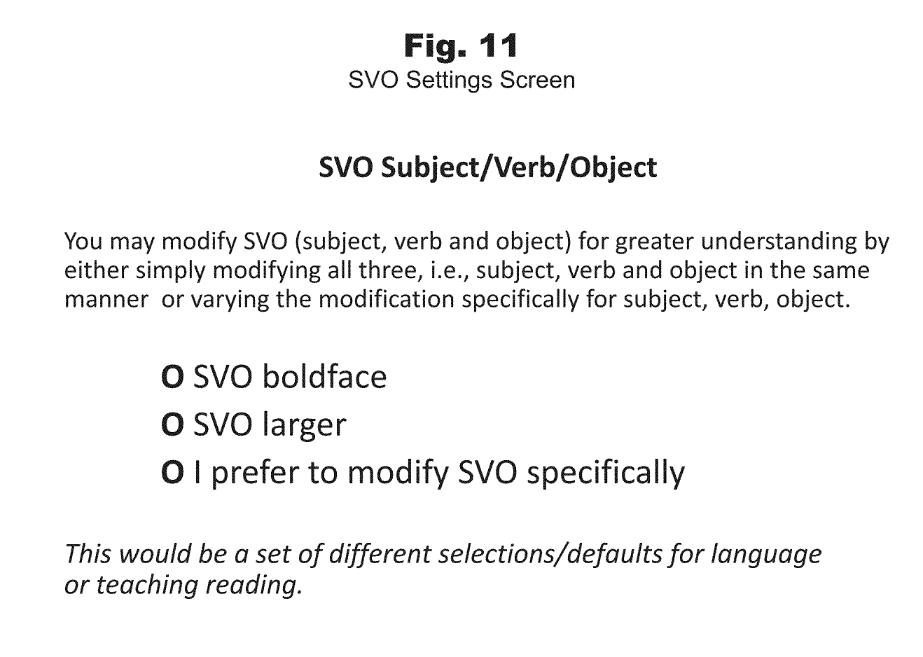

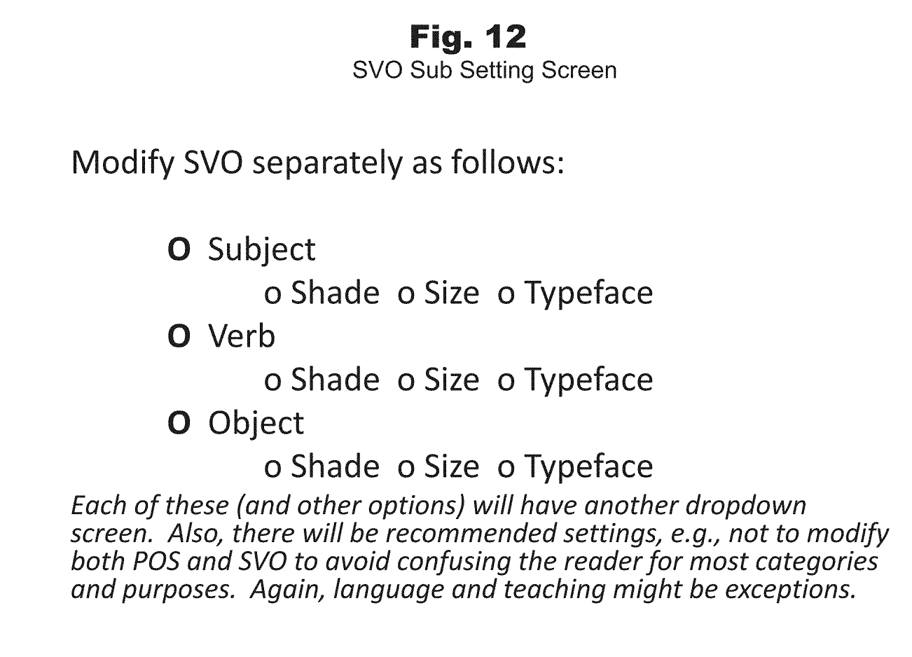

FIGS. 7-12 are general and sub-settings screen(s), respectively, for user modification of parts of speech (POS), for example, subject verb, object (SVO). Default settings are useable until such time as user can appreciate what factors provide the most assistance for their goal. POS focus is a well understood technique to quickly distill many texts. Often referred to as the “Reader's Digest” way of editing, the POS focus perhaps makes a text less dynamic in terms of what the author is conveying in mood, texture, etc., but it does create less verbiage to cover in a specified amount of time. One sure way to speed through a certain number of words is to eliminate some of them! While it may not be desirable to eliminate certain words altogether, emphasizing the ones that should draw a reader's attention and de-emphasizing those that can be, for the time spent, ignored or skimmed is going to result in a faster pace through the text. Different approaches can be used for different portions of the same text. An introductory part may receive little focus on the parts of speech, whereas the body of a text may receive more focus so as to enhance speed and comprehension.

The nature of the POS emphasis can be selected by the user, e.g., color, typeface or size, shading, background, etc. These can be controlled by user interface, e.g., a swipe function, during use as well.

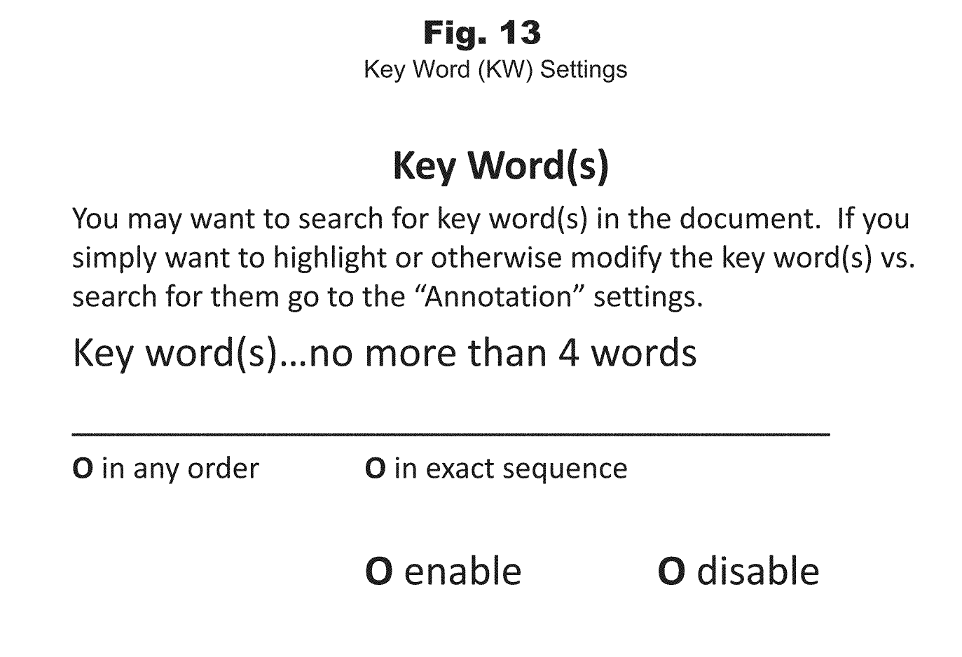

FIG. 13 is a settings query page for specified words and phrases. Key word identification is a popular method to direct reader attention using highlighted text. This well-known feature can be incorporated into the present system as it exists in many uses, and may include proximity and Boolean logic operators to guide the system to the outcome of the key word being sought.

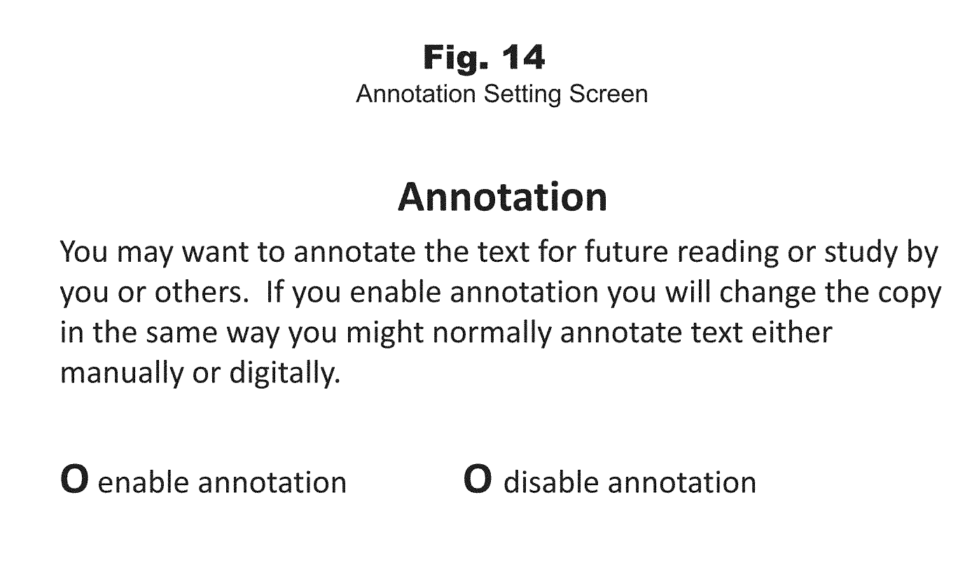

FIG. 14 is an annotation settings page. Annotating text using more familiar words and phrases to conjure specific meaning for a user is a well proven method of learning and comprehending. When students and other readers highlight and insert margin notes, the simple act of doing so makes for a separate associated memory of that text, in addition to the original exposure to that text. Annotation comes in many forms, i.e., margin writing, underlining, highlighting, bracketed paragraphs, etc. Any of these known techniques can be used in the present system.

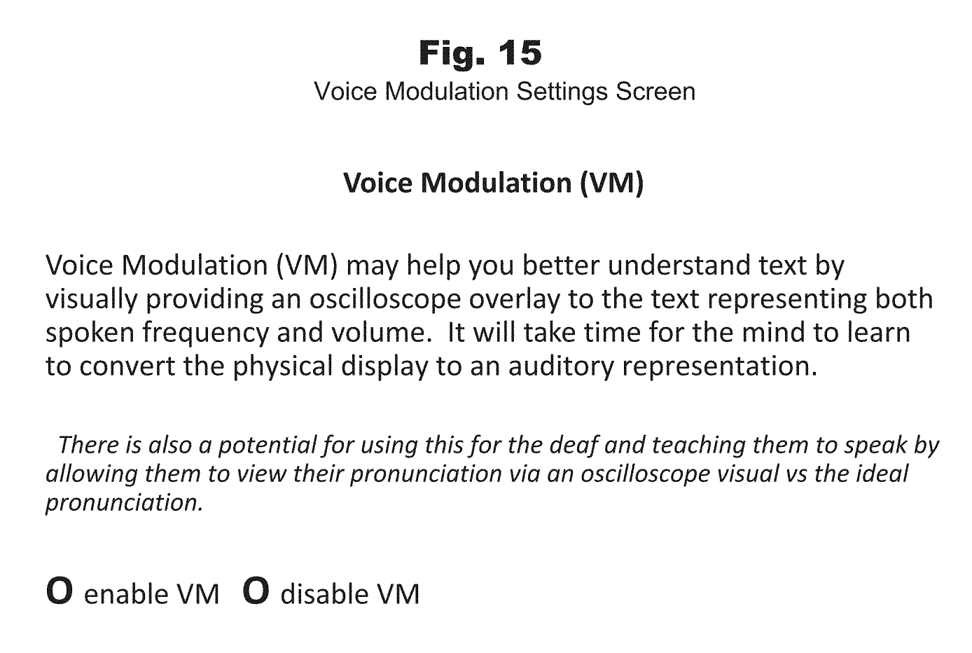

FIG. 15 is a text effect modulator corresponding to a spoken version of the text. The spoken word is typically more easily understood as to intent than the written word. The spoken word has speed, tone, inflection, that all imply an emphasis of or from the speaker. In text format, this intent often is lost. How many times has someone being communicated to in writing not “gotten” the joke, whereas if the joke could be heard, laughs all around. This feature of a voice modulation emphasis being overlaid onto text would supply an emphasis to the words being read that would convey what the spoken word already does. An oscilloscope overlay incorporated into the textual representation of a word can convey meaning well beyond mere definition.

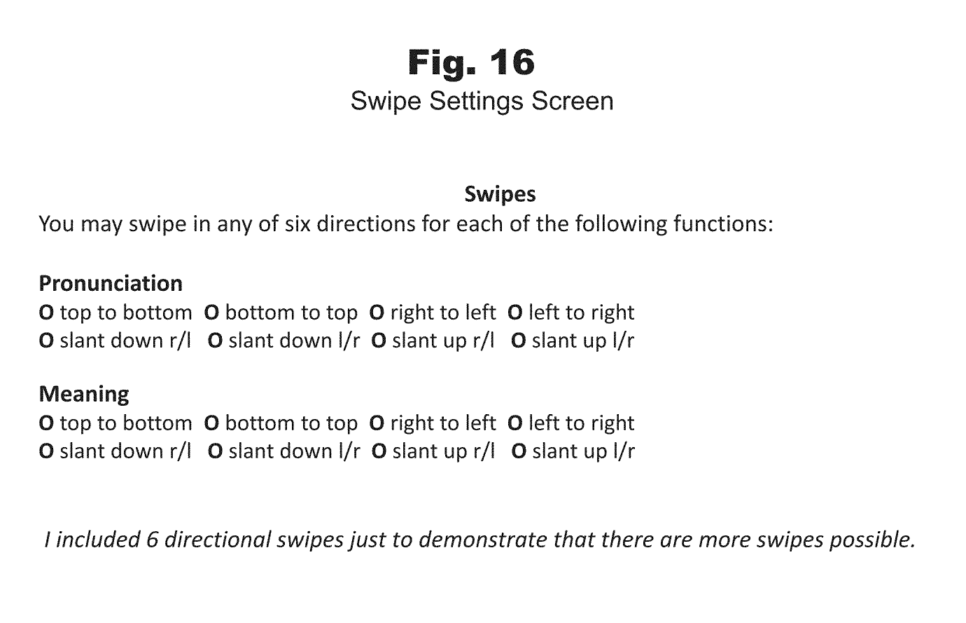

FIG. 16 is a swipe functions page for user interface, where lateral and vertical swipe actions for touch screens can be enabled. The various swipe actions can be customized according to the user interface that a user prefers.

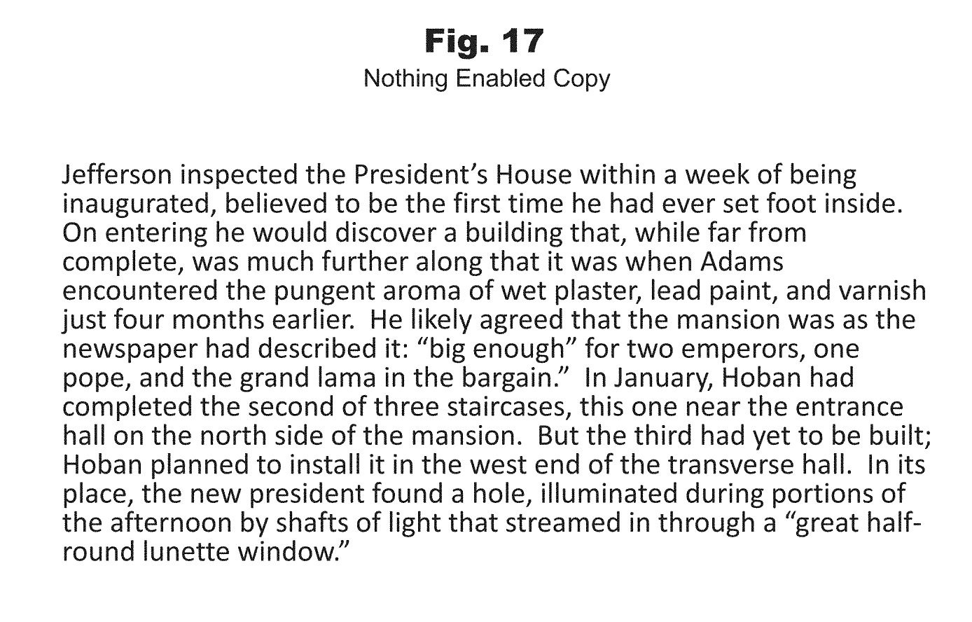

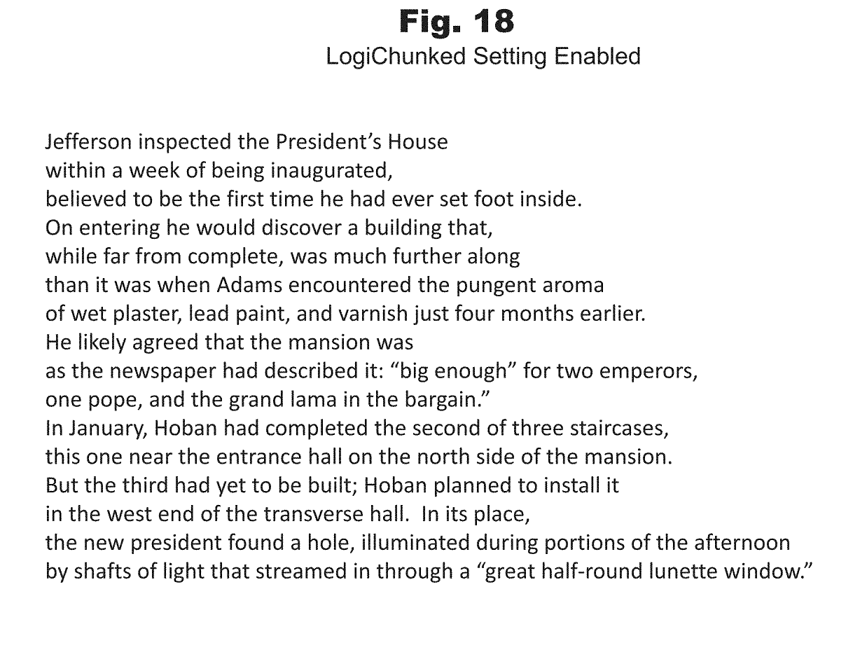

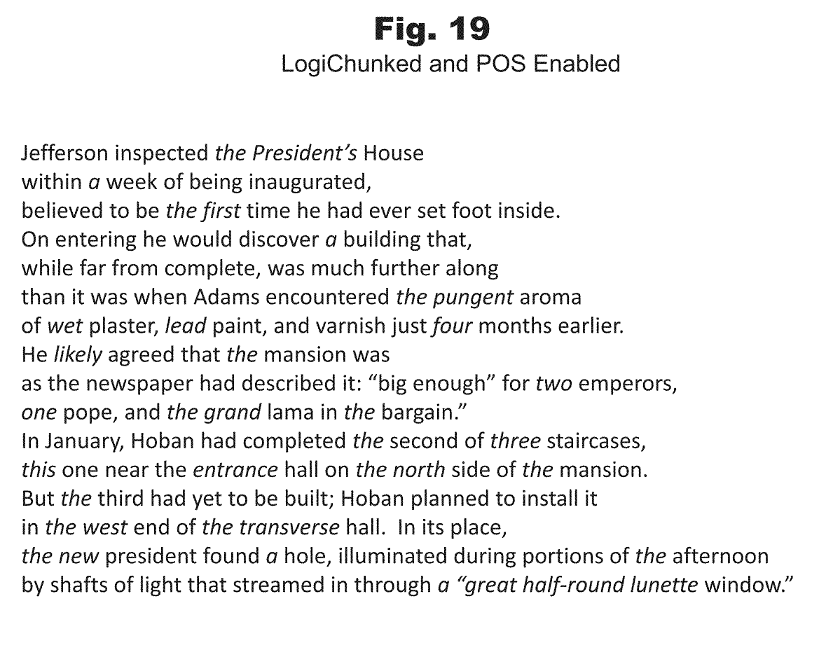

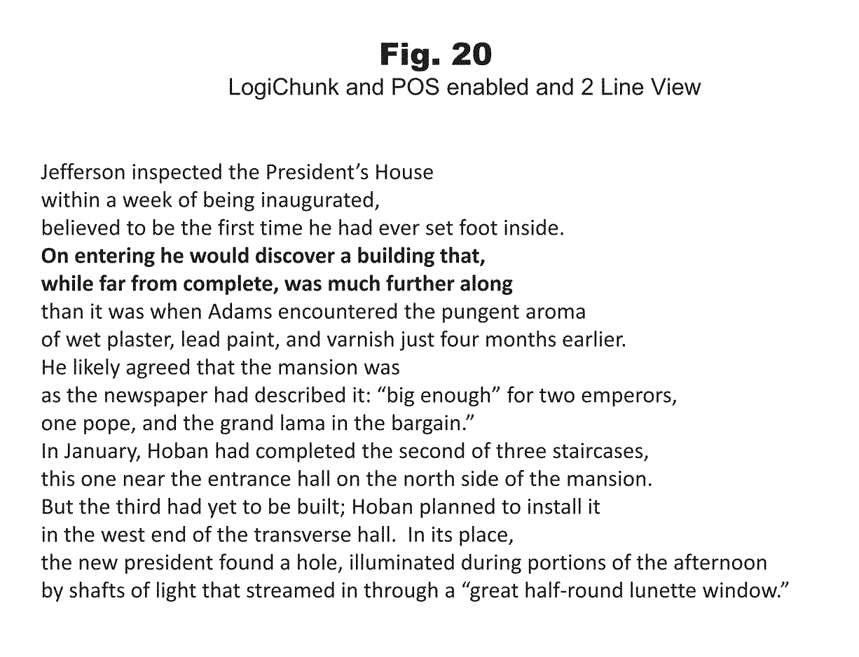

FIG. 17 is a text sample prior to treatment using the system and FIG. 18 is the text from FIG. 17 being modified using logical grouping. FIG. 19 is a treated text having both logical grouping and parts of speech modification. FIG. 20 is a treated text having logical grouping, parts of speech modification and line emphasis.

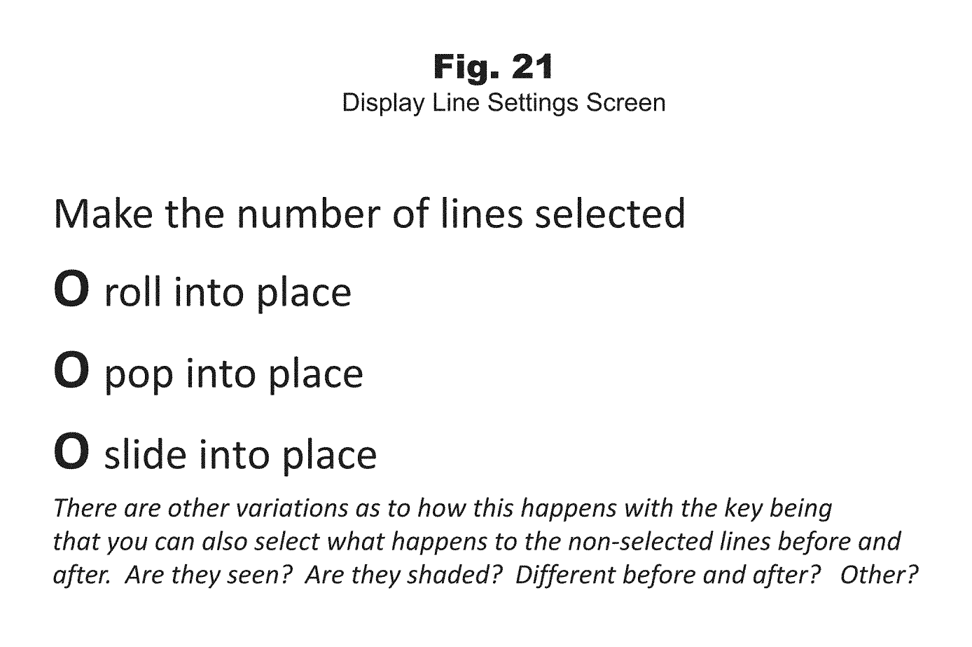

FIG. 21 is a settings screen for line count emphasis. This may be a rolling function set by the user or set by a training function.

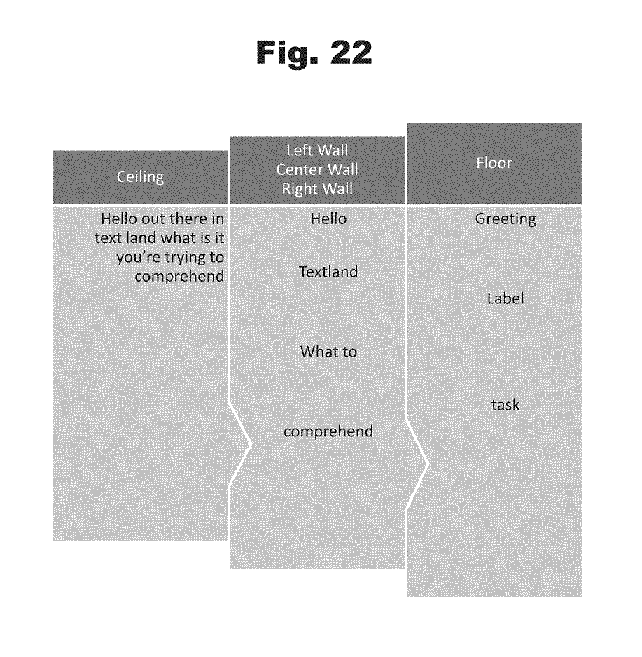

FIG. 22 is a conceptual display showing the system deployed in a virtual reality (VR) or augmented reality (AR) setting. Both VR and AR have been in use in many contexts for many years. As for VR, a primary application has been immersion into game play or training settings. The earliest uses would be aircraft simulators where a training or qualifying phase for an aircraft is initially accomplished in a device where control location and interface can be learned before progressing to the “real” world where consequences owing to a lack of familiarity are quite deadly! Likewise, although AR has received a bump of consumer interest with the likes of Google Glass, etc., the early uses were “heads-up” displays, again in aircraft, to assist in controlling and monitoring aircraft systems and flight capability, ie, flying on “instruments”. By now, even inexpensive automobiles have such AR capability, i.e., back-up cameras with guidelines to direct the vehicle, lane departure warning, etc.

In the context of the present system a VR/AR interface or interaction would rely on sensed eye movement tracking, but apply them to the VR/AR platform in the context of that experience. For VR, a person may, for example, enter a TMS “room” wherein the six room surfaces are displaying text, but each modified in accord with a previously described element of the system. For example, to the left, a wall might display the original text, straight ahead on a wall might be the text modified according to POS enhancement, and to the right would be definitions of keywords appearing in the text as it is scanned in accord with eye movement and focus. Below on the floor might be bolded adjectives or titles headings only. A wink or nod of the user might re-arrange the screens and displays according to need or application. A skimming screen could be replaced by a definitions screen for more detailed perusal, followed by a side-by-side technical description with highlighted numbers with schematics displayed to one side or the other.

Of course, although a VR setting might provide maximal interaction and efficiency, it is suitable only for certain settings where a VR capability is possible, ie, while seated and properly supported, etc. On the other hand, an AR use could be quite portable and useful in a variety of settings. A simple example would be to scan and magnify the text of a menu in a low light setting. Glasses work, but they also change the focus for everything else. A word only magnifier would leave all else intact as an image, and only enlarge words the eye is trained upon. This feature could be used to read road signs at night without disturbing the balance of a user's visual field, etc. The uses are, essentially, any circumstance where an AR setting would enhance text comprehension as that text is encountered in the “real” world. In addition, AR can be controlled as to degree of modification as to the viewed text. It can, for example, make the modified text become the primary object in view. In making a repair, an AR device could provide the text and schematics directly to the eye during a repair, as opposed to glancing to another screen or reference. A double wink returns the object viewer to return to a transparent device, or back to a TMS system modified text.

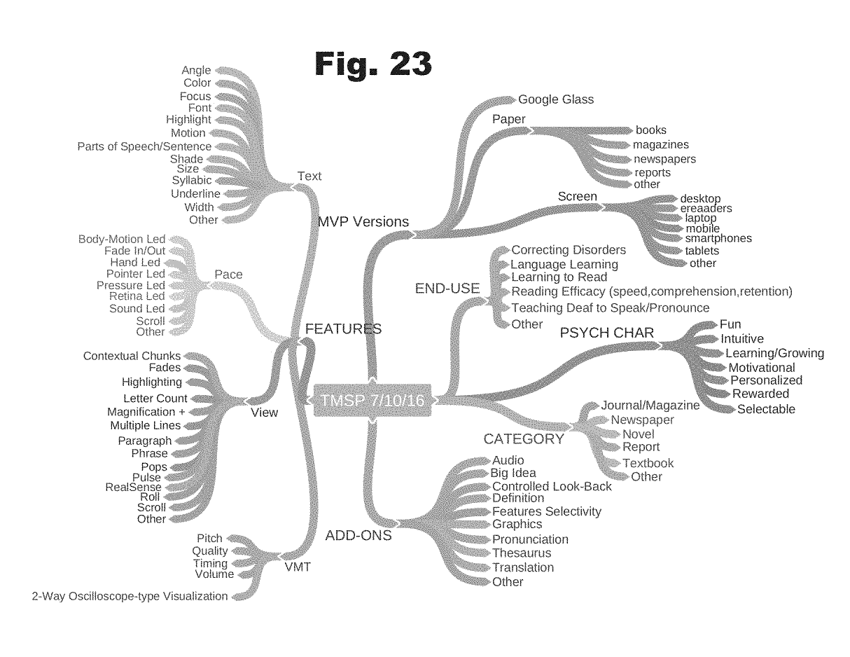

FIG. 23 is an expansive mind-map characterization of the ultimate extent of features and capabilities of the invented TMS system. This contemplates multiple platforms and a wide variety of user interface(s).

1. A computer implemented method of modifying text to enhance speed and extent of comprehension and retention thereof, comprising the steps of:
entering a text to be reviewed into the system
selecting thereafter the nature of the task contemplated for the text review
selecting the type of text being studied
selecting a grouping style within the text to be displayed
choosing and setting part of speech emphasis
executing logical text chunking function in view of selections and settings; and,
displaying the text so modified to the system user.

2. A method as in claim 1, wherein:
said entering step is accomplished using a copy and paste function.

3. A method as in claim 1, wherein:
said entering step is accomplished via scanning printed text.

4. A method as in claim 1, wherein:
said first selecting step is chosen from a group including skim, general understanding, highlight, annotate, compress, study, remember, thorough understanding, or learn.

5. A method as in claim 1, wherein:
said second selecting step is chosen from a group including fiction, non-fiction, business, technical, textbook, news, email, pleasure, promotional, or general.

6. A method as in claim 1, wherein:
said third selecting step is chosen from a display group including a maximum number of words in a line and the number of lines visible at one time.

7. A method as in claim 1, wherein:
said choosing step is chosen from a group including parts of speech, pace, display, key word, annotation, voice modulation, virtual reality, or augmented reality, and the nature of specific emphasis these group members should receive in the form of modified text.

8. A method as in claim 2, wherein:
said first selecting step is chosen from a group including skim, general understanding, highlight, annotate, compress, study, remember, thorough understanding, or learn.

9. A method as in claim 8, wherein:
said second selecting step is chosen from a group including fiction, non-fiction, business, technical, textbook, news, email, pleasure, promotional, or general.

10. A method as in claim 9, wherein:
said third selecting step is chosen from a display group including a maximum number of words in a line and the number of lines visible at one time.

11. A method as in claim 10, wherein:
said choosing step is chosen from a group including parts of speech, pace, display, key word, annotation, voice modulation, virtual reality, or augmented reality, and the nature of specific emphasis these group members should receive in the form of modified text.

12. A method as in claim 3, wherein:
said first selecting step is chosen from a group including skim, general understanding, highlight, annotate, compress, study, remember, thorough understanding, or learn.

13. A method as in claim 12, wherein:
said second selecting step is chosen from a group including fiction, non-fiction, business, technical, textbook, news, email, pleasure, promotional, or general.

14. A method as in claim 13, wherein:
said third selecting step is chosen from a display group including a maximum number of words in a line and the number of lines visible at one time.

15. A method as in claim 14, wherein:
said choosing step is chosen from a group including parts of speech, pace, display, key word, annotation, voice modulation, virtual reality, or augmented reality, and the nature of specific emphasis these group members should receive in the form of modified text.
